(19) United States
(12) Patent Application Publication
(10) Pub. No.: US 2021/0019704 A1
(43) Pub. Date: Jan. 21, 2021

(54) INTERACTIVE KNOWLEDGE BASE FOR PROJECT INFORMATION NAVIGATION

(71) Applicant: International Business Machines Corporation, Armonk, NY (US)

(72) Inventors: De Shuo Kong, BEIJING (CN); Yao Chen, BEIJING (CN); Hai Bo Zou, BEIJING (CN); Zheng Jie, BEIJING (CN)

(21) Appl. No.: 16/513,403

(22) Filed: Jul. 16, 2019

(51) Int. Cl. G06Q 10/10; G06N 5/02

(52) U.S. Cl. CPC G06Q 10/103; G06N 5/02

(57) ABSTRACT

A method, system and computer program product are disclosed for leveraging project information to build an interactive knowledge base. In an embodiment, the method comprises scanning project management systems to identify specified artifacts and defined attributes of the identified artifacts; building a timeline sequence for the identified artifacts; and from the timeline sequence built from the identified artifacts, creating one or more roadmaps showing given relationships of the identified artifacts and the defined attributes of the identified artifacts to the project. In an embodiment, a group of team members work on the project, and the timeline sequence is built from the activities of everyone of the team members. In an embodiment, a plurality of activity nodes are formed for each team member from the identified artifacts associated with the team member, and the timeline sequence is built from the activity nodes of the team member.

### BACKGROUND

This invention generally relates to information management, and more specifically, to building and using an interactive knowledge base.

Many complex projects—for example, software development, product development and testing, etc.—involve the management of large heterogeneous data and information repositories. These repositories may contain data and information of various types—text, spreadsheets, presentations, diagrams, programming code, ad-hoc databases, etc.—that have been created during different phases of the project lifecycle. These data and information may be stored in one or more repositories and form a Knowledge Base.

Newcomers to a project often do not know how to begin in a project, in an agile or flexible way. In different phases of a project, there are different artifacts that are frequently operated.

### SUMMARY

Embodiments of the invention provide a method, system and computer program product for leveraging project information to build an interactive knowledge base. In an embodiment, the method comprises scanning project management systems to identify specified artifacts and defined attributes of the identified artifacts; building a timeline sequence for the identified artifacts; and from the timeline sequence built from the identified artifacts, creating one or more roadmaps showing given relationships of the identified artifacts and the defined attributes of the identified artifacts to the project.

In embodiments of the invention, different roles can have different views when interacting with this knowledge base. Also, a group of team members can have the same view to ensure that they are all on the same page, i.e., same version of the identified artifacts.

In an embodiment, a group of team members work on the project, and each of the artifacts is associated with an activity of one or more of the team members.

In an embodiment, the building a timeline sequence from the identified artifacts includes building the timeline sequence from the activities of everyone of the team members.

In an embodiment, the building a timeline sequence for the identified artifacts includes, for each of the team members, forming a plurality of activity nodes from the identified artifacts associated with said each of the team members, and building the timeline sequence from the activity nodes of said each of the team members.

Embodiments of the invention leverage project document repositories to build an interactive knowledge base by which to organize, present, and take advantage of the knowledge content, to benefit all the project participants.

From the perspective of the repository, embodiments of the invention provide an interactive Knowledge Base. Documents and files in the Knowledge Base have a life track by keeping track of the file operators, roles, update times, etc. Visual information on this life track can help readers find the latest, most appropriate files he or she is looking for. Also, a new member of the project can have a quick view of the project progress by means of these files, with the project's active period. The newcomer has a clear view on which file or files are critical for his or her role, which file is a master reference file, and which file has the team lately focused on.

From the perspective of the team workers on the project, embodiments of the invention act as an assistant between teammates for the same roles. Teammates that have the same role in the project should focus on the same period of the project. Embodiments of the invention provide proactive reminders to the same roles on any asymmetric information. For example, if a person is referring to or working on a file which has been replaced or abandoned for a while, that person will have a notification that the file has been replaced or abandoned.

In embodiments of the invention, the Knowledge Base can connect the documents in a number of ways such as by their read queues and relationships created by different role activities, which can bring a learning path clearly to a newcomer on the project.

From the perspective of project management, embodiments of the invention provide a schedule track for the project per the file status in the repository, according to milestone information, and send an alarm to the project management of a risk of current deliverables with a target.

Embodiments of the invention provide a files/asset management repository which has project related files/asset information including timelines, active durations, and focused roles. Embodiments of the invention generate streams with files/assets.

Embodiments of the invention provide a knowledge repository for all project participants. From this knowledge repository, the project participants can quickly get required project information with guidance by active times and role based instructions.

Embodiments of the invention provide a cognitive repository which is generated by the project participants, and which changes with time and project evolution. This repository displays the project emphasis and team contributions in different dimensions.

Embodiments of the invention provide a repository with role based authentication for different views of project information.

### BRIEF DESCRIPTION OF THE SEVERAL VIEWS OF THE DRAWINGS

FIG. 1 shows a system architecture for a project information system in which embodiments of the invention may operate.

FIG. 2 illustrates modules used in embodiments of the invention.

FIG. 3 is a flow chart illustrating embodiments of the invention.

FIG. 4 is a swimlane diagram of files accessed during a project.

FIG. 5 shows a role roadmap for the project formed from swimlane diagrams.

FIG. 6 shows a project level roadmap for the project formed from roadmap diagrams.

FIG. 7 depicts a processing unit that may be used in embodiments of the invention.

### DETAILED DESCRIPTION

Many complex projects—for example, software development, product development and testing, etc.—involve the management of large heterogeneous data and information repositories. These repositories may contain data and information of various types—text, spreadsheets, presentations, diagrams, programming code, ad-hoc databases, etc.—that have been created during different phases of the project lifecycle. These data and information may be stored in one or more repositories and form a Knowledge Base.

Current Knowledge Bases are static repositories and are used to read and write data and for management. A lot of information from these data bases is missed that could benefit the project.

Individual who are associated with a project are referred to as team members of the project. Team members include project managers, who are the individuals associated with creating a given project, and project contributors. Project contributors are generally the authors and editors of documents.

More and more projects adapt an agile style to do management during the life cycle of the project; the people working on a project often change. The handover or transferring usually is done in two ways: by people; cannot cover all transfer tasks in a short time; and by centralized documents repositories; various documents and versions of documents.

Oftentimes, it is time consuming for new members on a project to become familiar with the project, and it may also be confusing for other members on the project, with so many documents and versions of the documents. When trying to get familiar with a project, a new member may feel helpless to get all related information since the project may have too many cross documents and there may be different emphasis based on roles.

It is difficult to manage all documents/assets, especially over a long time, for different teams and different target audiences. All the teams may share the same Knowledge Base but not actually have interactions with each other, or the teams may be unfamiliar with the progress of counterparts and with the contents of the Knowledge Base.

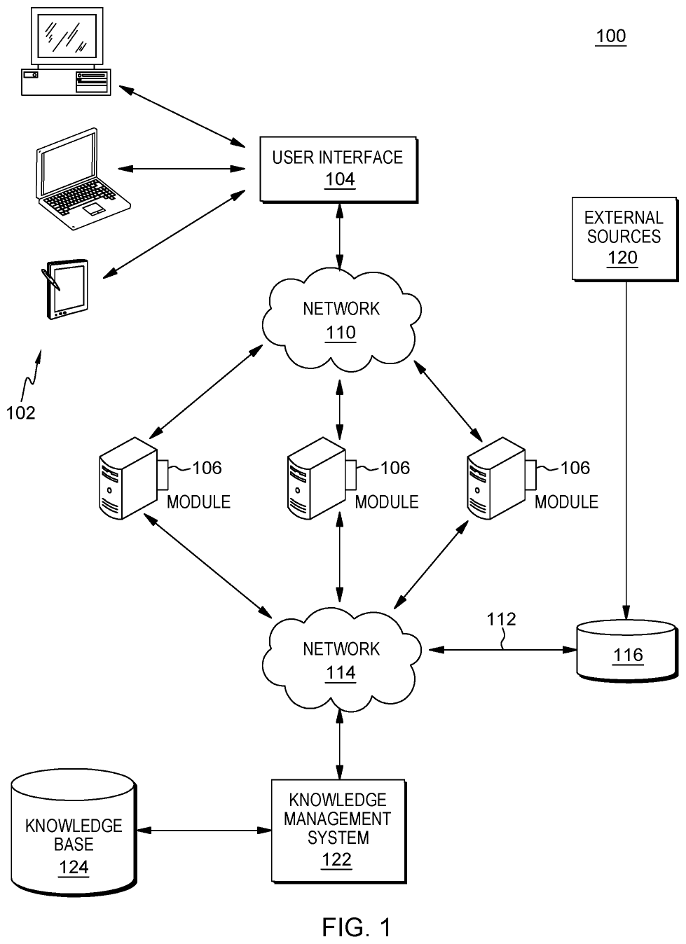

FIG. 1 shows an architecture for a project information system in which embodiments of the invention may operate. In the system 100, one or more client computing devices 102 may display a graphical user interface 104 configured to receive information from one or more users and interact with one or more software modules 106 by way of network 110. Examples of client computing devices 102 may include smartphones, desktop computers, laptop computers, tablets, and PDAs, among others. Software modules 106 may include any software used by key areas of an organization such as, for example, accounting software, human resources software, project management, organizational social networks, search engines and/or any other suitable software from where knowledge of an organization may be derived. In addition, each software module 106 may be executed by a server, a single computer or multiple computers in a distributed configuration.

User interface 104 displayed in client computing devices 102 may exhibit features for supporting human-computer interactions and also providing support for human-to-human collaboration for co-located and geographically diverse work teams alike. User interface 104 may act as a single portal for accessing different software modules 106 and may be tailored to users depending on the access rights predetermined for those specific users. In another embodiment, an independent user interface may exist for each software module 106.

Interaction between client computing devices 102 and software modules 106 may generate raw data such as user profiles, documents, project information, metrics, emails and worksheets among others. Software modules 106 may transmit the raw data, represented at 112, through network connection 114 to a database 116 for storing. Database 116 may be implemented through known in the art database management systems (DBMS).

External sources 120 may also feed raw data to database 116. Examples of external sources 120 may include the world wide web, external social networks, external consulting, third party providers, external project sources and/or any external data that may serve to produce knowledge.

A knowledge management system 122 may manage and process the flow of information within the project information system. For example, knowledge management system 122 may retrieve and process raw data stored in database 116 to consequently derive knowledge from the raw data. Knowledge may then be stored in a knowledge base 124. Knowledge management system 122 may also pull knowledge from knowledge base 124 when requested by client computing devices 102 or software modules 106.

Knowledge management system 122 may include one or more computers suitable for executing knowledge management software according to embodiments described here. Knowledge base 124 may be implemented through known in the art database management systems (DBMS).

The system architecture 100 may include more or fewer devices and components than as shown in FIG. 1. For example, embodiments of the invention may use the same database for the raw data and corresponding information. Also, the disclosed system architecture 100 may include different components that may dynamically interact with each other through networks 110 and 114. Networks 110 and 114 may refer to any suitable connections between computers such as, for example, intranets, local area networks (LANs), virtual private networks (VPNs), wide area networks (WAN) and the Internet, among others. Embodiments of the invention may be implemented with one network.

Embodiments of the invention may use a plurality of repositories. Each repository may contain thousands of documents of various types—text, spreadsheets, presentations, diagrams, ad-hoc databases, programming code, etc.—that have been created during different phases of a project lifecycle. Each repository may contain documents of any type, created during any stage of a project. A repository may also include files not created during a project lifecycle.

Various repository structures may be used in embodiments of the invention. For example, one repository may be provided containing every document to be analyzed. Alternatively, a plurality of repositories may be provided where each repository may contain only documents of certain types, or only documents created during certain phases of the project, or only documents created at a certain geographical location.

In embodiments of the invention, each repository has an associated repository type that defines the structure of the repository, such as the underlying directory structure for the repository. Additionally, a repository may be a simple repository having a single directory, or a complex repository that may store metadata associated with each file kept in the repository.

Embodiments of the invention leverage project document repositories to build an interactive knowledge base by which to organize, present, and take advantage of the knowledge content, to benefit all the project participants.

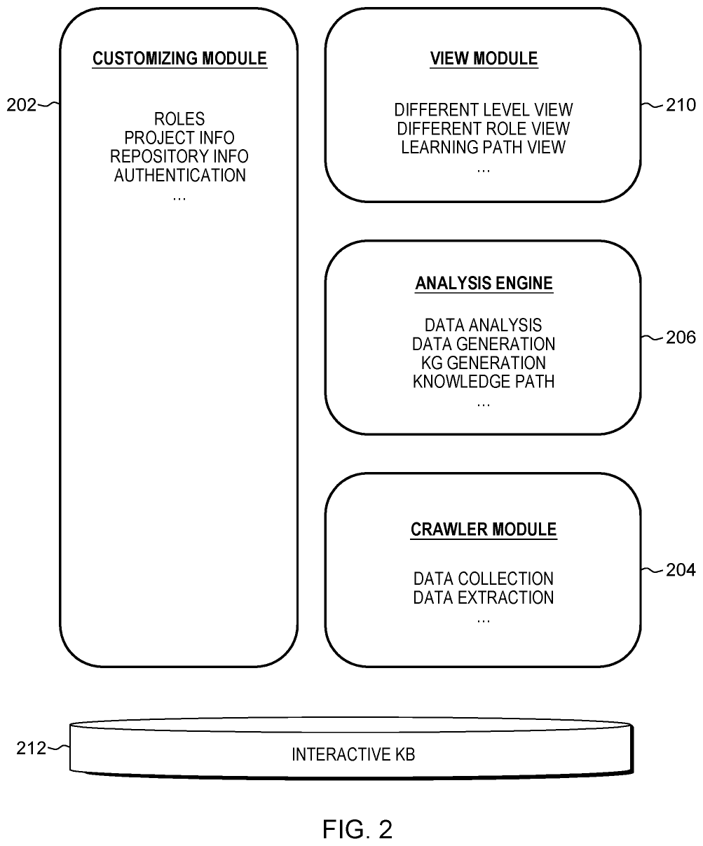

With reference to FIG. 2, embodiments of the invention include four main modules: a Customizing, or Pre-Defining, module 202, a Crawler module 204, an Analysis Engine 206, and a View module 210. These modules are used in interactive operations with Knowledge Base 212.

The Pre-Defining Module 202 is for role management and other customizing functions. Crawler module 204 is for data collection and a first step data clean. The Analysis Engine 206 is for data analysis for the final presenter for different roles, and for generating the document connection lines and other required information. The View module 210 is for the different level views for users to achieve certain objectives.

The Crawler module 204 scans the project's management system, e.g. version control system, chat records, daily activities, and extracts major attributes, e.g. timestamps of key project artifacts. The crawler learns from natural language processing and identifies the active artifacts from their context and their frequency. These output data are put in nodes of a timeline in a data processing module (not shown). A sequence of the nodes is built of owner, or operation type (e.g. read, upload, download, update, etc), and maintained.

In embodiments, an intelligent module (not shown) further looks after frequently operated and active artifacts in the timeline, and a roadmap is created for the artifacts. This timeline brings a clear vision of the project, helping one to understand the overall project and the key nodes in the project. Key nodes are important stages or milestones in a project. From the roadmap, anyone's ownership in the project is clearly shown.

In embodiments, two types of charts are available through the above-features: One timeline with everyone's key activities; and Anyone's activity nodes from the timeline.

In embodiments of the invention, every project participant will own his or her own files/asset, working timeline, in the repository, and the files/assets are generated as a diagram. The x-axis is the timeline, and the y-axis is a swimlane that represents different files/asset that the project owner is working on. The diagram displays the files/asset that one owner is working on as the time goes on. Time granularity can be defined. If the owner works on a certain file at a time point, then there will be a point in the diagram in a certain location of the diagram. If he or she spends much time on the file, or works on the file frequently in the time duration, then the size of the point in the diagram is bigger.

In embodiments, all personal diagrams are overlapped by roles. Diagrams of the same role in the project are overlapped to generate a role based files/asset lifecycle repository diagram. From the role based file lifecycle repository diagram, the points from each individual are used to compose the trend of different files with the timeline. This diagram is a good reference for the team to check to determine what files were focused on in the past, in different time periods, as well as the sequence in which the files are worked on.

In embodiments, all role based diagrams are combined to get the project level view about the file/asset lifecycle repository diagram. The diagrams of all roles in the project are combined as the project level view. This view can be used for the project management, from a files/asset management perspective, and also can be used as a complete knowledge pool to train newcomers to the project.

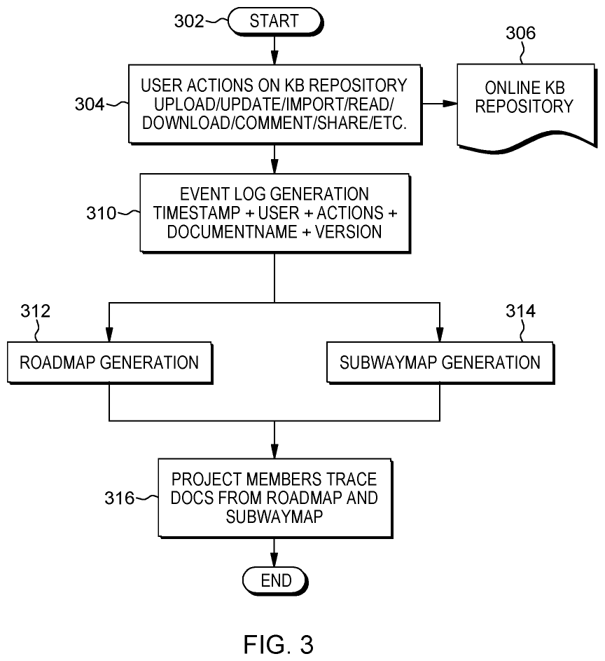

FIG. 3 is a flow chart showing an embodiment of the invention. The method starts at 302; and at 304, a person's actions on the Knowledge Base repository are scanned and major attributes of key project artifacts are extracted. The activities that are scanned may include uploads, updates, imports, reads, downloads, comments, shares, and others. The extracted information is stored, at 306, in an online Knowledge Base repository.

At 310, event logs are generated. Each log may, for example, include a timestamp, and may identify the user, his or her actions, a document name, and document version identification. The generated event logs are used, at 312, to generate a roadmap and, at 314, to generate a subway map (discussed below). At 316, documents for the project members are generated from the roadmap and the subway map.

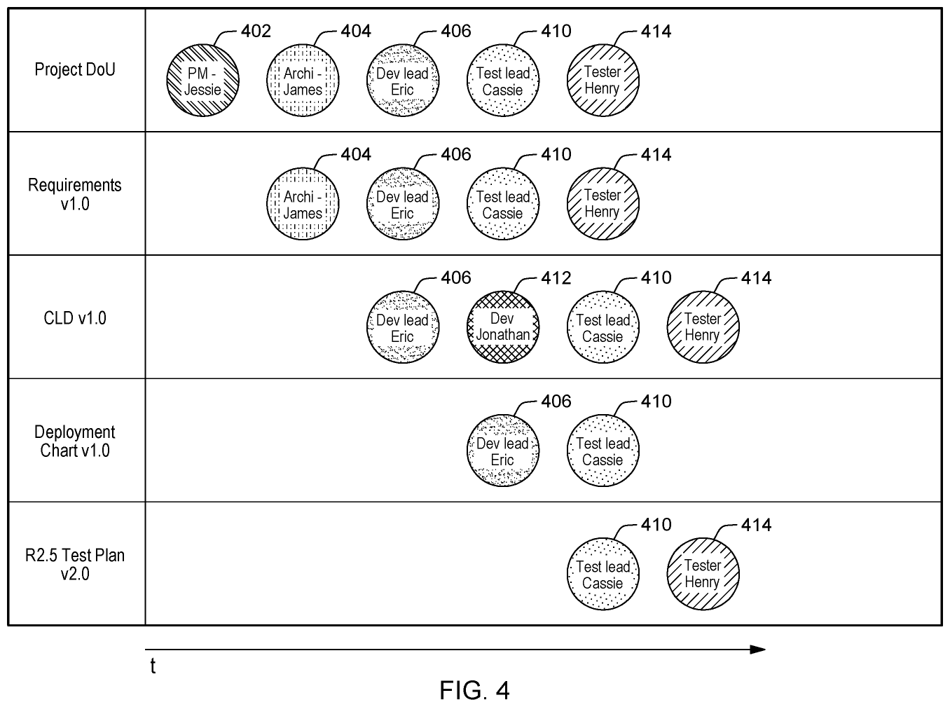

FIGS. 4, 5 and 6 illustrate documents that are generated in embodiments of the invention.

With reference to FIG. 4, a first step is to use a swimlane diagram to draw individual roadmaps. The x-axis of the swimlane diagram represents time. The y-axis of the swimlane diagram represents files (such as documents, json files, excel files, etc.). Each lane represents a file, and the markers in the lanes represent accesses to a file by a person/role. The example shown in FIG. 4 has five lanes representing files referred to as Test Plan, Deployment Chart, CLD, Requirements, and Project DoU. This Figure shows accesses to those files by six people, each in a different role. In particular, the Figure shows accesses to the files by Jessie, James, Eric, Jonathan, Carrie, and Henry in the roles of, respectively, Project Manager 402, Architect 404, Development Lead 406, Test Lead 410, Developer 412, and Tester 414. Each role has a different type of marker in the swimlane diagram.

FIG. 4 shows that, at a first time, the Project DoU file was accessed by Jessie in the role of Project Manager 402; at a later time, the Project DoU and Requirements files were accessed by James in the role of Architect 404; and at a later time, the files Project DoU, Requirements, and CLD were accessed by Eric in the role of Development Lead 406. Subsequently, the files Project DoU and Requirements were accessed by Cassie in the role of Test Lead 410, the file CLD was accessed by Jonathan in the role of Developer 412, and the file Deployment Chart was accessed by Eric in the role of Development Lead 406. At a later time, the files Project DoU and Requirements were accessed by Henry in the role of Tester 414; and the files CLD, Development Chart, and Test Plan were accessed by Cassie in the role of Test Lead 410. Subsequently, Henry, in the role of Tester 412, accessed the files CLD and Test Plan.

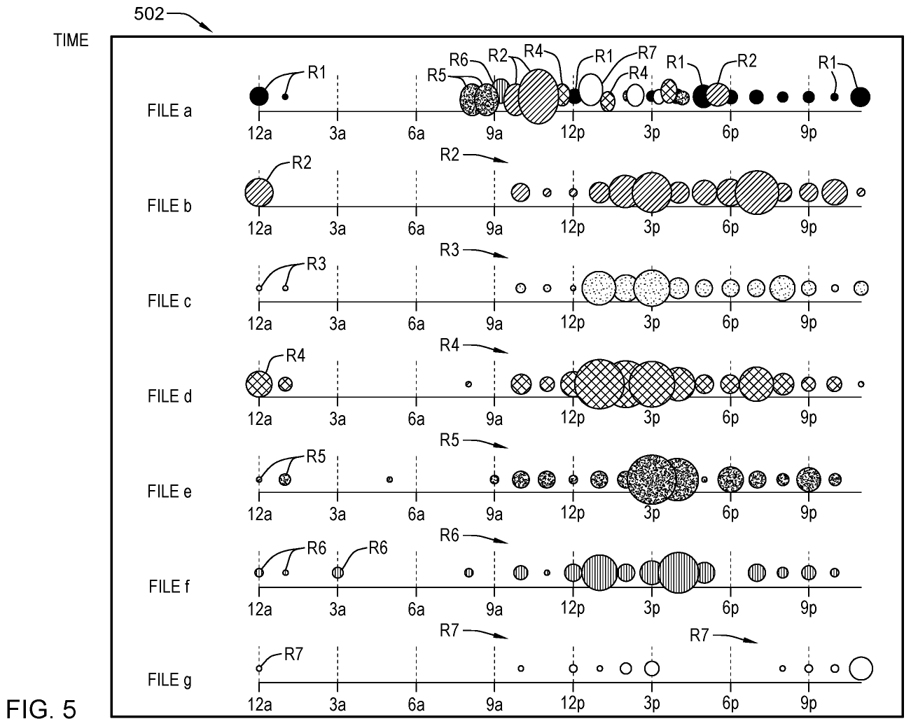

With reference to FIG. 5, a second step is to combine the swimlane diagrams of each of the roles to produce a role roadmap 502. Each dot or circle in the roadmap represents a file/artifact active status according to different role/individual. The size of the dot in the role roadmap represents a degree of activity of the file/artifact; the bigger the dot, the more active the file/artifact. Normally, one file will have one role focus; however, in some situations, multiple roles will work on the same files. For example, FIG. 5 shows that “File a” works as a master file for all the team for some time, and later, people refer to this file for less time.

FIG. 5 indicates the activity of various files, over the course of one day, and the roles that accessed those files. As shown in the Figure, over the course of the day, file a is accessed a number of times by a number of roles. The file is accessed by role R1 at around 12 am, and by roles R2, R3 and R4 from about 8 am to 6 pm, and the file continues to be accessed by roles until after 9 pm. File b is accessed by role R2 at around 12 am and also from 9 am until after 9 pm. Files c, e and f are accessed by roles R3, R5 and R6, respectively, between 9 am until after 9 pm. File d is accessed by role R4 at 12 am and also from between 9 am until after 9 pm. File g is accessed for a relatively smaller amount of time, primarily between 12 noon until after 9 pm.

FIG. 5 shows that File a is accessed the most, by the most roles; and that from noon to 9 pm, files b, c and d are accessed a significant number of times, for significant lengths of time, by roles R2, R3 and R4 respectively.

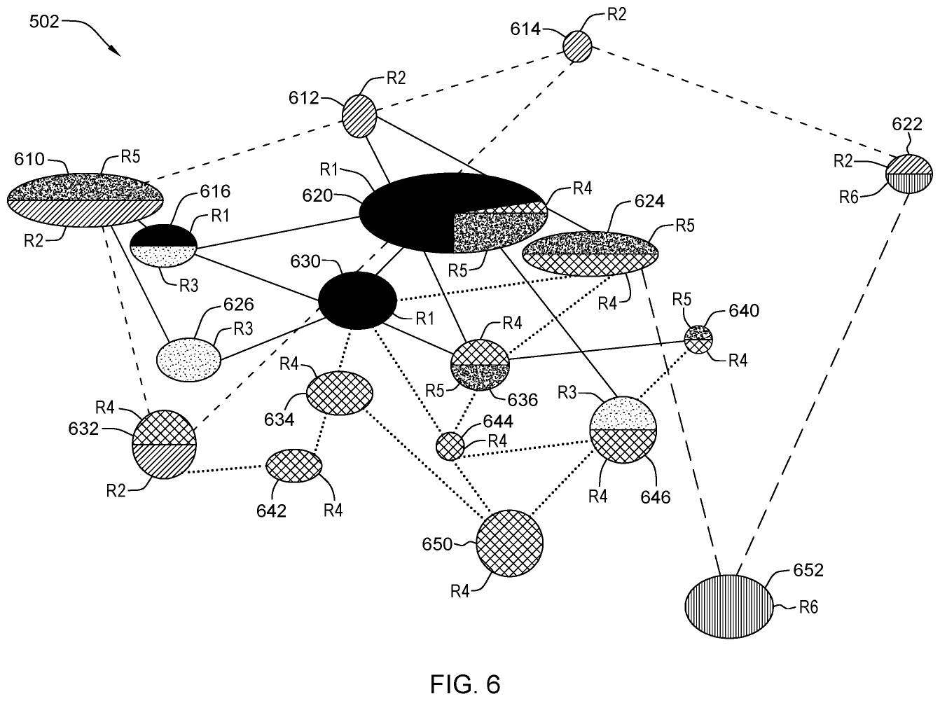

A next step, as shown in FIG. 6, is to combine all the diagrams together, with different roles and different files, according to the timeline. This diagram is a roadmap 602 for all the files in one project, with their creation times, working roles, and tracks to other files.

In FIG. 6, the dots represent artifacts, and the size of each dot represents the degree of activity of the artifact. The lines between the artifacts represent connections between the artifacts. More specifically, FIG. 6 shows artifacts 610, 612, 614, 616, 620, 622, 624, 626, 630, 632, 634, 636, 640, 642, 644, 646, 650 and 652. Roles R2 and R5 access artifact 610, Role R2 accesses artifacts 612 and 614, Roles R1 and R3 access artifact 616, Roles R1, R4 and R5 access artifact 620, and Roles R2 and R6 access artifact 622. Roles R4 and R5 access artifact 624, Role R3 accesses artifact 626, Role R1 accesses artifact 630, Roles R2 and R4 access artifact 632, Role R4 accesses artifacts 634, 642, 644 and 650. Roles R4 and R5 access artifacts 636 and 640, Roles R3 and R4 access artifact 646, and Role R6 accesses artifact 652.

In embodiments of the invention, the following steps are done to combine all the diagrams together.

Step 1: Every individual person, in the beginning, is represented as one fixed size/fixed percentage in one team (pre-defined) dot in the swim-lane diagram. As time goes by, the dot stretches as actual read/update activities are done. Sometimes, the dot (the person) will jump to other files for some while. All these individual dots are kept in the log repository.

Step 2: The KB system puts some individuals with the same role (pre-defined) together by time (horizontal axis) and files (vertical axis) in the same color, then a trend/roadmap can be seen from a historical time point. If more roles data are put in one picture, then a colorful roadmap by roles can be obtained, indicating the time zone/roles of interest for different files. If, at one time there are more read/updates activities for one file, the size of the dot gets bigger. So, more updates are seen as bigger dots, and longer updates are seen as longer dots.

At this time, if the files of one role are connected together by a timeline, a subway map is obtained which indicate the file connections by logic. For example, in a developer view, one week ago, ‘UI Design’ ppt was updated/read frequently; this file has a connection to ‘User Story Design’ doc, which is also updated/read frequently; and then is the ‘Code Design’ doc in this week. Per this subway map, the doc relationships can be seen by time, and the subway map gives a newcomer with a good indication to read the documents, and the subway map makes document connections clear.

Step 3: By the previous steps, the KB gets the logs by role, by time, by docs. With all this information, different view types can be generated for different purpose.

For example, from a project schedule perspective, project timelines and milestones can be checked to determine whether the project is in a healthy status (for instance, by checking whether the deliverable doc is active or going to be active per submay map).

From a management perspective, can check by roles and documents can be checked to determine which roles produce more documents, and whether they follow the project process to read/produce deliverables.

From an individual perspective, team members can check whether they are on the same page with other team members in the same role, and whether they can learn the materials by a common file subway map.

To implement the above, the view module supports different roles, to view the pictures or diagrams in different levels, by timeline, by files, by roles, etc.

These steps produce a “live” Knowledge Base with roadmap, as shown in FIG. 6, for the project. Different routes represent different files, and different types of points represent different roles. By this roadmap, the files in one project, and the work path for each role (document relationship between each other) can be tracked. Additionally, more information can be obtained such as what is the progress of the current project from the perspective of the deliverables, and if there is any risk in the future.

In embodiments of the invention, the roadmap is a dynamic view with multiple dimensionality for one Knowledge Base. Different roles can select different views to get required information. The roadmap is transparent to users, without any further input; however, the roadmap can provide easier entrance to the project and full information for users.

Whether a user drills down to a deep level of the roadmap, or views the roadmap from its highest level, the focus of the roadmap can be different by role. The roadmap can be customized from the beginning of the project, and can send smart reminders during project operation to avoid failures due to information asymmetry.

The roadmap can provide a quick learning path for a newcomer, by role, in a timeline link, which can help the newcomer have a clear view of the project history. With integration with project management, the roadmap can provide a proactive risk assessment based on deliverables, role focus, etc., which is a key to a project. The roadmap can also be viewed as the quality assessment for different teams. Integration of deliverables and immediate performance feedback benefits the working on the project.

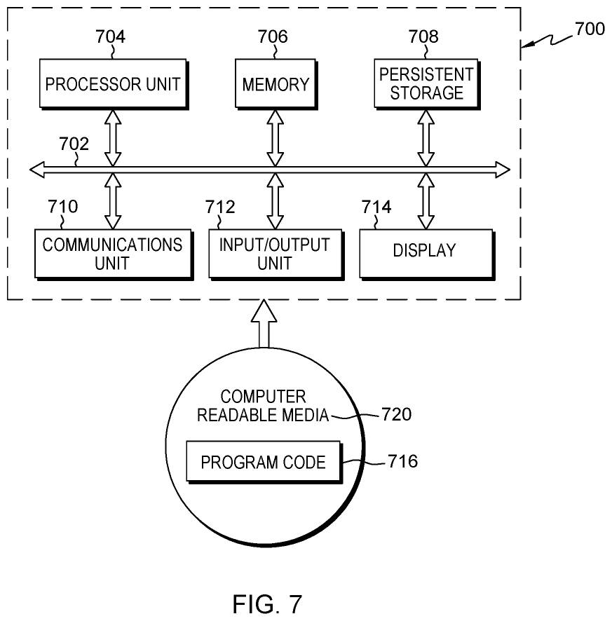

With reference to FIG. 7, a block diagram of a data processing system 700 is shown. Data processing system 700 is an example of a processing unit that may be used in, or with, embodiments of the invention. For example, data processing system 700 may also be used in or with the system architecture of FIG. 1.

In this illustrative example, data processing system 700 includes communications fabric 702, which provides communications between processor unit 704, memory 706, persistent storage 808, communications unit 710, input/output (I/O) unit 712, and display 714.

Processor unit 704 serves to execute instructions for software that may be loaded into memory 806. Processor unit 704 may be a set of one or more processors or may be a multi-processor core, depending on the particular implementation. Memory 706 and persistent storage 808 are examples of storage devices. Memory 806, in these examples, may be a random access memory or any other suitable volatile or non-volatile storage device. Persistent storage 708 may take various forms depending on the particular implementation. For example, persistent storage 708 may be a hard drive, a flash memory, a rewritable optical disk, a rewritable magnetic tape, or some combination of the above.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard and mouse. The input/output unit may also provide access to external program code 716 stored on a computer readable media 720. In addition, input/output unit 712 may send output to a printer. Display 714 provides a mechanism to display information to a user.

Those of ordinary skill in the art will appreciate that the hardware in FIG. 7 may vary depending on the implementation. Other internal hardware or peripheral devices, such as flash memory, equivalent non-volatile memory, or optical disk drives and the like, may be used in addition to or in place of the hardware depicted in FIG. 7.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of leveraging project information to build an interactive knowledge base, the method comprising:
scanning project management systems to identify specified artifacts and defined attributes of the identified artifacts;
building a timeline sequence for the identified artifacts; and
from the timeline sequence built from the identified artifacts, creating one or more roadmaps showing given relationships of the identified artifacts and the defined attributes of the identified artifacts to the project.

2. The method according to claim 1, wherein:
a group of team members work on the project, and each of the artifacts is associated with at least one activity of one or more of the team members; and
the building a timeline sequence from the identified artifacts includes building the timeline sequence from the activities of everyone of the team members.

3. The method according to claim 1, wherein:
a group of team members work on the project, and each of the artifacts is associated with one or more of the team members; and
the building a timeline sequence for the identified artifacts includes, for each of the team members,
forming a plurality of activity nodes from the identified artifacts associated with said each of the team members, and
building the timeline sequence from the activity nodes of said each of the team members.

4. The method according to claim 1, wherein:
a group of team members work on the project; each of the team members has an associated role on the project; and during the project, each of the team members accesses one or more of the artifacts; and
the building a time line sequence for the identified artifacts includes, for each of the artifacts, identifying the roles of the team members who access said each artifacts during the project.

5. The method according to claim 4, wherein the creating one or more roadmaps includes creating a personal roadmap for each of the team members based on the artifacts accessed by the role associated with said each team member.

6. The method according to claim 4, wherein the creating one or more roadmaps includes creating a role roadmap based on the roles of the team members who access the artifacts.

7. The method according to claim 6, wherein the creating a role roadmap includes, for each of the artifacts accessed by the team members, representing in the role roadmap a degree of activity of said each artifact in the project.

8. The method according to claim 1, wherein the project management system has a multitude of artifacts and each of the multitude of artifacts has a context and a frequency in the project management system; and
the identifying the specified artifacts includes identifying the specified artifacts from the contexts and the frequencies of the multitude of artifacts of the project management system.

9. The method according to claim 1, wherein:
the scanning project management systems to identify specified artifacts and defined attributes of the identified artifacts includes, for each of the specified artifacts, generating an event log identifying said each artifact and at least a timestamp for said each artifact; and
the building a timeline sequence for the identified artifacts includes using said timestamps to order the identified artifacts in the timeline sequence.

10. The method according to claim 9, wherein:
the defined attributes of the identified artifacts include ownership and operation types of the identified artifacts; and
the building a timeline sequence for the identified artifacts further includes identifying the ownership and operation types of each of the identified artifacts in a node of the timeline sequence.

11. A system for leveraging project information to build an interactive knowledge base, the system comprising:
one or more processors; and
a memory coupled to the one or more processors;
said one or more processors configured for:
scanning project management systems to identify specified artifacts and defined attributes of the identified artifacts;
building a timeline sequence for the identified artifacts; and
from the timeline sequence built from the identified artifacts, creating one or more roadmaps showing given relationships of the identified artifacts and the defined attributes of the identified artifacts to the project.

12. The system according to claim 11, wherein a group of team members work on the project, and each of the artifacts is associated with an activity of one or more of the team members; and wherein:
the building a timeline sequence from the identified artifacts includes building the timeline sequence from the activities of everyone of the team members.

13. The system according to claim 11, wherein a group of team members work on the project, and each of the artifacts is associated with one or more of the team members; and
the building a timeline sequence for the identified artifacts includes, for each of the team members,
forming a plurality of activity nodes from the identified artifacts associated with said each of the team members, and
building the timeline sequence from the activity nodes of said each of the team members.

14. The system according to claim 11, wherein a group of team members work on the project; each of the team members has an associated role on the project; and during the project, each of the team members accesses one or more of the artifacts; and
the building a time line sequence for the identified artifacts includes, for each of the artifacts, identifying the roles of the team members who access said each artifacts during the project.

15. The system according to claim 11, wherein the project management system has a multitude of artifacts and each of the multitude of artifacts has a context and a frequency in the project management system; and
the identifying the specified artifacts includes identifying the specified artifacts from the contexts and the frequencies of the multitude of artifacts of the project management system.

16. A computer program product for leveraging project information to build an interactive knowledge base, the computer program product comprising a computer readable storage medium having program instructions embodied therewith, the program instructions executable by a processor to cause the processor to:
scan project management systems to identify specified artifacts and defined attributes of the identified artifacts;
build a timeline sequence for the identified artifacts; and
from the timeline sequence built from the identified artifacts, create one or more roadmaps showing given relationships of the identified artifacts and the defined attributes of the identified artifacts to the project.

17. The computer program product according to claim 16, wherein a group of team members work on the project, and each of the artifacts is associated with an activity of one or more of the team members; and wherein:
the build a timeline sequence from the identified artifacts includes building the timeline sequence from the activities of everyone of the team members.

18. The computer program product according to claim 16, wherein a group of team members work on the project, and each of the artifacts is associated with one or more of the team members; and
the build a timeline sequence for the identified artifacts includes, for each of the team members, forming a plurality of activity nodes from the identified artifacts associated with said each of the team members, and
building the timeline sequence from the activity nodes of said each of the team members.

19. The computer program product according to claim 16, wherein a group of team members work on the project; each of the team members has an associated role on the project; and during the project, each of the team members accesses one or more of the artifacts; and
the build a time line sequence for the identified artifacts includes, for each of the artifacts, identifying the roles of the team members who access said each artifacts during the project.

20. The computer program product according to claim 16, wherein the project management system has a multitude of artifacts and each of the multitude of artifacts has a context and a frequency in the project management system; and
the identify the specified artifacts includes identifying the specified artifacts from the contexts and the frequencies of the multitude of artifacts of the project management system.
